(19) United States
(12) Patent Application Publication
(10) Pub. No.: US 2026/0072383 A1
(43) Pub. Date: Mar. 12, 2026

(54) IMAGE HEATING DEVICE AND IMAGE FORMING APPARATUS

(71) Applicant: CANON KABUSHIKI KAISHA, Tokyo (JP)

(72) Inventor: MITSUNARI ITO, Shizuoka (JP)

(21) Appl. No.: 19/318,532

(22) Filed: Sep. 4, 2025

(30) Foreign Application Priority Data
Sep. 9, 2024 (JP) 2024-155379

(51) Int. Cl. G03G 15/20; G03G 15/00; H05B 6/06; H05B 6/14; H05B 6/36

(52) U.S. Cl. CPC G03G 15/2053; G03G 15/2064; G03G 15/5004; G03G 15/55; G03G 15/80; H05B 6/06; H05B 6/145; H05B 6/365; G03G 2215/2035

(57) ABSTRACT

An image heating device configured to heat an image formed on a recording material, includes a tubular rotary member, a magnetic core material, an excitation coil, an inverter, a control unit, and a power cutoff unit configured to cut off supply of power from the inverter to the excitation coil regardless of a control state of the inverter by the control unit in a case where the power input from the inverter to the excitation coil exceeds a threshold, the control unit is configured to change a driving frequency of the inverter. The power cutoff unit is configured to change a value of the threshold based on a value of the driving frequency of the inverter.

### BACKGROUND

### Field of the Technology

The present disclosure relates to an image heating device that heats an image formed on a recording material, and an image forming apparatus.

### Description of the Related Art

In an electrophotographic image forming apparatus such as a printer or a copying machine, a toner image corresponding to image data is transferred to a recording material such as a recording sheet or an overhead projector (OHP) sheet, and then the toner image transferred to the recording material is fixed to the recording material by being heated and pressurized by a fixing device serving as an image heating device. Among various types of fixing devices, a configuration using a fixing film in which a resistive heat generation layer that generates heat when a current flows by electromagnetic induction is provided over the entire circumference in a circulation movement direction has been proposed (see JP 2014-026267 A).

In addition, an induction heating type image heating device that changes a heat generation distribution in a longitudinal direction by changing a driving frequency of a current flowing through a coil is also disclosed (see JP 2016-24348 A).

Here, regardless of whether or not the fixing film is used, a general heating fixing device does not function properly if at least one of a heat generation element, a power supply, a temperature detection unit, and a control unit does not function properly. Furthermore, when an abnormality occurs in a central processing unit (CPU), the device may fail due to overheating. Therefore, such a fixing device includes an overheating safety device (hereinafter, referred to as an abnormal heating safety device) that operates at the time of occurrence of the following abnormality to avoid overheating at the time of runaway energization (see JP H08-248813 A).

Specifically, JP H08-248813 A proposes a configuration in which a safety device (thermoprotector) such as a thermal fuse or a thermoswitch is incorporated in an energization circuit of a heat generation element to cut off energization for the heat generation element when overheating occurs due to runaway energization. That is, in the fixing device of JP H08-248813 A, when a temperature of a thermistor disposed in the vicinity of the heat generation element becomes equal to or higher than a predetermined temperature, the energization for the heat generation element is cut off by the safety device.

As described above, when the safety device is operated based on the temperature of the heat generation element detected by the thermistor, overheating of the heat generation element can be prevented. However, for example, in a case where there is a lag between a temperature rise of the thermistor and an actual temperature of the heat generation element, there is a possibility that the operation of the safety device is delayed.

### SUMMARY

According to one aspect of the present disclosure, an image heating device configured to heat an image formed on a recording material, includes a tubular rotary member including a conductive layer, a magnetic core material installed inside the rotary member and forming an open magnetic path in a longitudinal direction, an excitation coil wound around the magnetic core material such that a spiral axis extends in the longitudinal direction of the magnetic core material, an inverter configured to cause an alternating current to flow through the excitation coil, a control unit configured to control the inverter to cause the alternating current to flow through the excitation coil and generate an alternating magnetic flux in the magnetic core material to perform electromagnetic induction heating of the rotary member, and a power cutoff unit configured to cut off supply of power from the inverter to the excitation coil regardless of a control state of the inverter by the control unit in a case where the power input from the inverter to the excitation coil exceeds a threshold. The control unit is configured to change a driving frequency of the inverter. The power cutoff unit is configured to change a value of the threshold based on a value of the driving frequency of the inverter.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of an image forming apparatus according to a first embodiment.

FIG. 2 is a schematic side cross-sectional view of a fixing device.

FIG. 3 is a schematic front view of the fixing device.

FIG. 4 is a perspective projection view of the fixing device and a connection circuit block diagram.

FIG. 5 is a diagram illustrating a driving frequency and a heat generation distribution in a longitudinal direction of a surface of a fixing film.

FIG. 6A illustrates an equivalent circuit of an excitation coil and a heat generation layer of the fixing film.

FIG. 6B illustrates an equivalent circuit of the excitation coil and the heat generation layer of the fixing film.

FIG. 6C illustrates an equivalent circuit of the excitation coil and the heat generation layer of the fixing film.

FIG. 6D illustrates an equivalent circuit of the excitation coil and the heat generation layer of the fixing film.

FIG. 7 is an explanatory diagram illustrating a phenomenon in which apparent permeability is lower at an end portion than at a central portion.

FIG. 8 is a diagram illustrating lines of magnetic force in a case where ferrite is disposed in a uniform magnetic field H.

FIG. 9 is a diagram for describing equivalent inductances of a central portion and an end portion of a coil.

FIG. 10A is a diagram illustrating a distribution of the apparent permeability and the number of turns in the longitudinal direction, and an equivalent circuit thereof.

FIG. 10B is a diagram illustrating a distribution of the apparent permeability and the number of turns in the longitudinal direction, and an equivalent circuit thereof.

FIG. 11 is a graph illustrating frequency characteristics of combined impedances at the central portion and the end portion.

FIG. 12 is a graph illustrating frequency characteristics of amounts of generated heat at the central portion and the end portion.

FIG. 13A is a diagram illustrating a relationship between a film surface temperature and a temperature of a thermistor internally mounted on the film.

FIG. 13B is a diagram illustrating a relationship between the film surface temperature and the temperature of the thermistor internally mounted on the film.

FIG. 14 is a control flowchart illustrating an operation of a second safety circuit according to the first embodiment.

FIG. 15 is a diagram illustrating a limit input power setting table of the second safety circuit according to the first embodiment.

FIG. 16 is a diagram illustrating a modified example of the limit input power setting table of the second safety circuit.

FIG. 17 is a perspective view of an excitation coil and a magnetic core according to a second embodiment, and a block diagram for describing control of a heating unit.

FIG. 18 is a schematic diagram for describing a configuration for detecting a rotation/stop state of a fixing film.

FIG. 19 is a control flowchart illustrating an operation of a second safety circuit according to the second embodiment.

FIG. 20 is a diagram illustrating a limit input power setting table of the second safety circuit according to the second embodiment.

FIG. 21 is a perspective view of an excitation coil and a magnetic core according to a third embodiment, and a block diagram for describing control of a heating unit.

FIG. 22 is a control flowchart illustrating an operation of a second safety circuit according to the third embodiment.

FIG. 23A is a diagram illustrating a limit input power setting table of the second safety circuit according to the third embodiment.

FIG. 23B is a diagram illustrating a limit input power setting table of the second safety circuit according to the third embodiment.

### DESCRIPTION OF THE EMBODIMENTS

### First Embodiment

### Schematic Configuration of Image Forming Apparatus

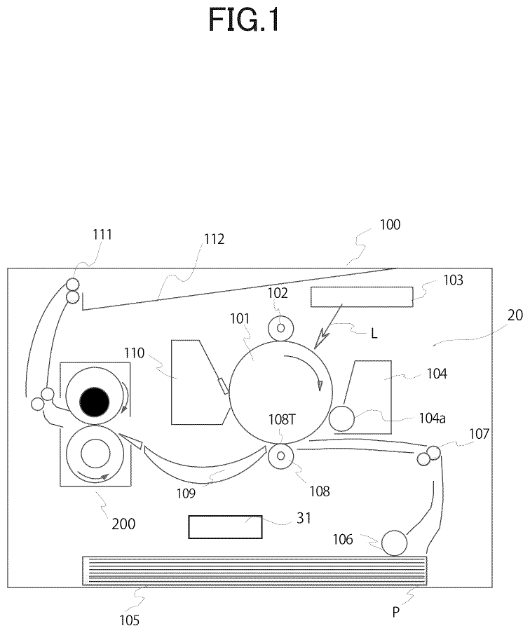

Hereinafter, a fixing device serving as an image heating device and an image forming apparatus 100 including the fixing device according to an embodiment of the present disclosure will be described with reference to the drawings. As illustrated in FIG. 1, the image forming apparatus 100 is an electrophotographic laser beam printer, and includes a feeding cassette 105, a feeding roller 106, a registration roller 107, an image forming unit 20, a fixing device 200, and a control unit 31. The feeding cassette 105 is a recording material supporting unit that supports a recording material P and is configured to load and store the recording material P. The feeding roller 106 is a feeding unit that feeds the recording material P stored in the feeding cassette 105, and is configured to separate and feed the recording materials P loaded and stored in the feeding cassette 105 one by one. The registration roller 107 is a recording material conveyance unit that conveys the recording material fed from the feeding cassette 105 toward the image forming unit 20, and is configured to convey the recording material P according to an image formation timing of the image forming unit 20.

The image forming unit 20 is configured to form an image on the recording material P, and includes a photosensitive drum 101, a charging roller 102, an exposure device 103, a developing device 104, a transfer roller 108, and a cleaning device 110. These members are disposed around the photosensitive drum 101, and the charging roller 102 uniformly charges the photosensitive drum 101 in terms of polarity and potential, the photosensitive drum 101 being rotationally driven at a predetermined speed in an arrow direction in the drawing. The exposure device 103 is a laser beam scanner, and outputs laser light subjected to ON/OFF modulation according to a time-series electrical digital pixel signal of target image information input from external equipment such as a host computer to scan and expose (irradiate) a charged surface of the photosensitive drum 101. The developing device 104 includes a developing roller 104a that supplies a developer (toner) to the surface of the photosensitive drum 101, and is configured to develop an electrostatic latent image formed on the surface of the photosensitive drum 101 by the exposure device 103 with the developer. The transfer roller 108 forms an image transfer nip 108T with the photosensitive drum 101 at a transfer portion, and a transfer voltage is applied to the transfer roller 108 such that a toner image formed on the photosensitive drum 101 is transferred onto the recording material P. The cleaning device 110 is provided downstream of the transfer nip 108T in a rotation direction of the photosensitive drum 101, and is configured to remove residual toner after transfer, paper dust, and the like on the photosensitive drum 101.

The fixing device 200 is an electromagnetic induction heating type image heating device, and includes a fixing film 121 serving as a heating rotary member, and a pressure roller 128 that forms a fixing nip portion N together with the fixing film 121. Then, the fixing device 200 forms the fixing nip portion N using the fixing film 121 and the pressure roller 128, and is configured to heat and pressurize the unfixed toner image transferred onto the recording material by the fixing nip portion N to fix the toner image to the recording material P.

The control unit 31 is a controller that controls each unit of the image forming apparatus 100 described above, and includes a read only memory (ROM) and a random access memory (RAM) serving as a storage unit, a central processing unit (CPU) serving as a computation unit, various input/output control circuits (not illustrated), and the like.

Since the image forming apparatus 100 is configured as described above, when a feeding start signal is output from the control unit 31 to the feeding roller 106, the feeding roller 106 is driven to separate and feed the recording materials P in the feeding cassette 105 one by one. When the recording material Pis fed from the feeding cassette 105, the recording material P is conveyed to the transfer nip 108T by the registration roller 107 according to a timing at which the toner image on the photosensitive drum 101 is conveyed to the transfer nip 108T. Then, when the transfer voltage (transfer bias) whose polarity is opposite to that of the toner is applied to the transfer roller 108, the toner image is transferred onto the recording material P at the transfer nip 108T.

When the toner image is transferred onto the recording material, the recording material P bearing the unfixed toner image is conveyed to the fixing device 200 by a pre-fixing conveyance guide 109, and the toner image is pressurized and heated in the fixing device 200 and fixed to the recording material P. Then, the recording material to which the toner image is fixed is discharged from a discharge port 111 onto a discharge tray 112 serving as a discharge portion.

### Configuration of Fixing Device

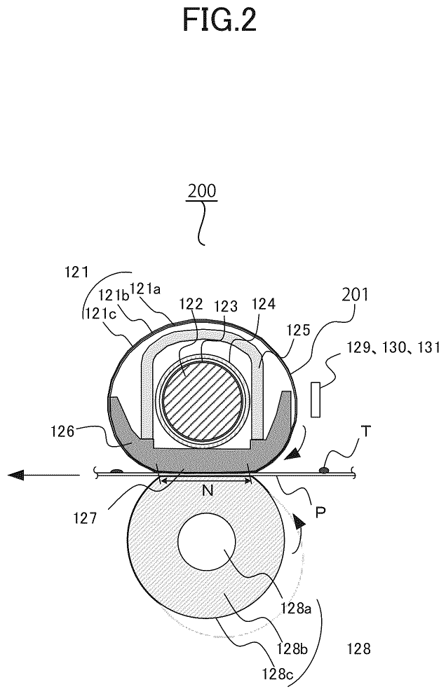

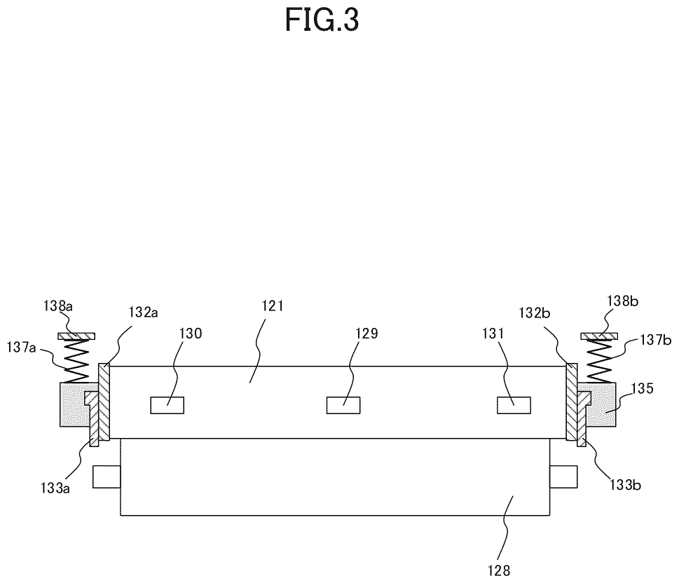

Next, a configuration of the fixing device 200 will be described with reference to FIGS. 2 and 3. As illustrated in FIG. 2, the fixing device 200 serving as the image heating device includes a heating unit 201 and the pressure roller 128 serving as a pressure member that is in pressure contact with the heating unit 201. The fixing nip portion N is formed by causing the pressure roller 128 to be in pressure contact with the heating unit 201, the recording material P on which the toner image is formed is nipped and conveyed to the fixing nip portion N, and the toner image is heated and fixed. The heating unit 201 includes a heat generation layer 121a serving as a conductive layer, and includes the fixing film 121 serving as a rotatable cylindrical rotary member. In addition, the heating unit 201 includes an excitation coil 123 and one or more temperature detection elements that detect a temperature of the fixing film 121 (three temperature detection elements 129, 130, and 131 in the embodiment).

The fixing film 121 is a tubular rotary member including the heat generation layer 121a serving as the conductive layer formed of a conductive member, an elastic layer 121b stacked on an outer surface of the heat generation layer 121a, and a release layer 121c serving as a surface layer stacked on an outer surface of the elastic layer 121b. In the present embodiment, the fixing film 121 is a cylindrical body having a diameter of 10 to 50 mm, the heat generation layer 121a is a metal film having a film thickness of 10 to 50 μm, and the elastic layer 121b is formed by molding silicone rubber having a hardness of 20 (JIS-A, 1 kg load) to 0.1 mm to 0.3 mm. Then, the elastic layer 121b is coated with a fluororesin tube having a thickness of 50 μm to 10 μm as the release layer 121c (surface layer). When a high-frequency voltage is applied and an alternating magnetic flux whose polarity is periodically inverted acts on the fixing film 121, an induced current is generated and the heat generation layer 121a generates heat. The heat is transmitted to the elastic layer 121b and the release layer 121c, the entire fixing film 121 is heated, and the recording material P passing through the fixing nip portion N is heated to fix a toner image T.

In addition, the heating unit 201 is provided with a magnetic core 122 serving as a magnetic core material inserted into a hollow portion of the fixing film 121 and disposed in a longitudinal direction of the fixing film 121. The excitation coil 123 is formed by being wound around the magnetic core 122 in a direction intersecting a rotation axis of the fixing film 121 and extending along the rotation axis. Further, a sleeve guide 126 is inserted into the fixing film 121 along the fixing nip portion N, a pressure stay 125 opened so as to have an inverted U-shaped cross section is mounted so as to surround the excitation coil 123, and a lower edge of the pressure stay 125 is in contact with the sleeve guide 126.

### Pressure Configuration

Next, a pressure configuration of the fixing device 200 will be described. As illustrated in FIG. 3, pressure springs 137a and 137b are compressed between both end portions of the pressure stay 135 and spring receiving members 138a and 138b on an apparatus chassis side, respectively, so that a pressing force is applied to the pressure stay 135. In the heating unit 201 of the present embodiment, a pressing force with a total pressure of about 100 N to 250 N (about 10 kgf to about 25 kgf) is applied. As a result, a lower surface of the sleeve guide 126 formed of a heat-resistant resin such as a PPS resin and an upper surface of the pressure roller 128 are in pressure contact with each other with the fixing film 121 interposed therebetween to form the fixing nip portion N having a predetermined width.

Flange members 132a and 132b are fitted to both left and right end portions of the sleeve guide 126 from outer end sides, respectively, and are rotatably attached in a state in which left and right positions are fixed by regulating members 133a and 133b. The flange members 132a and 132b receive end portions of the fixing film 121 and serve to regulate a deviation of the fixing film 121 in the longitudinal direction of the sleeve guide at the time of rotation of the fixing film 121. As a material of the flange members 132a and 132b, a material having a high heat resistance such as a liquid crystal polymer (LCP) resin may be adaptable.

The pressure roller 128 includes a core metal 128a, a heat-resistant elastic material layer 128b formed to concentrically and integrally coat the core metal in a roller shape, and a release layer 128c forming a surface layer. The elastic material layer 128b may be formed of a material having a high heat resistance, such as silicone rubber, fluororubber, or fluorosilicone rubber. Both end portions of the core metal 128a are rotatably supported between chassis side sheet metals (not illustrated) of the apparatus via conductive bearings. Further, the pressure roller 128 is rotationally driven by a driving unit (not illustrated) in a counterclockwise direction indicated by an arrow, and when the pressure roller 128 rotates, a rotational force acts on the fixing film 121 by a frictional force with an outer surface of the fixing film 121.

### Description of Temperature Detection Element

Next, as illustrated in FIG. 2, the temperature detection elements 129, 130, and 131 of the heating unit 201 are disposed upstream of the fixing film 121 (heating unit 201) in a conveyance direction in which the recording material P is conveyed to the heating unit 201. As illustrated in FIG. 3, the temperature detection elements 129, 130, and 131 are disposed at a center portion and both end portions in the longitudinal direction of the heating unit 201 so as to face the fixing film 121. In the present embodiment, the temperature detection elements 129, 130, and 131 are implemented by non-contact thermistors, but the temperature detection elements 129, 130, and 131 may also be implemented by, for example, contact thermistors internally mounted on the fixing film 121. With such a configuration, for example, a surface temperature of the fixing film 121 can be maintained at or adjusted to a predetermined target temperature based on a detection result of the temperature detection element 129 positioned at the central portion. In addition, the temperature detection elements 130 and 131 disposed in the vicinity of the end portions of the fixing film 121 can detect a temperature rise of a non-sheet passing region when the small-size recording materials P are continuously printed.

### Configuration of Induced Current Generation Mechanism

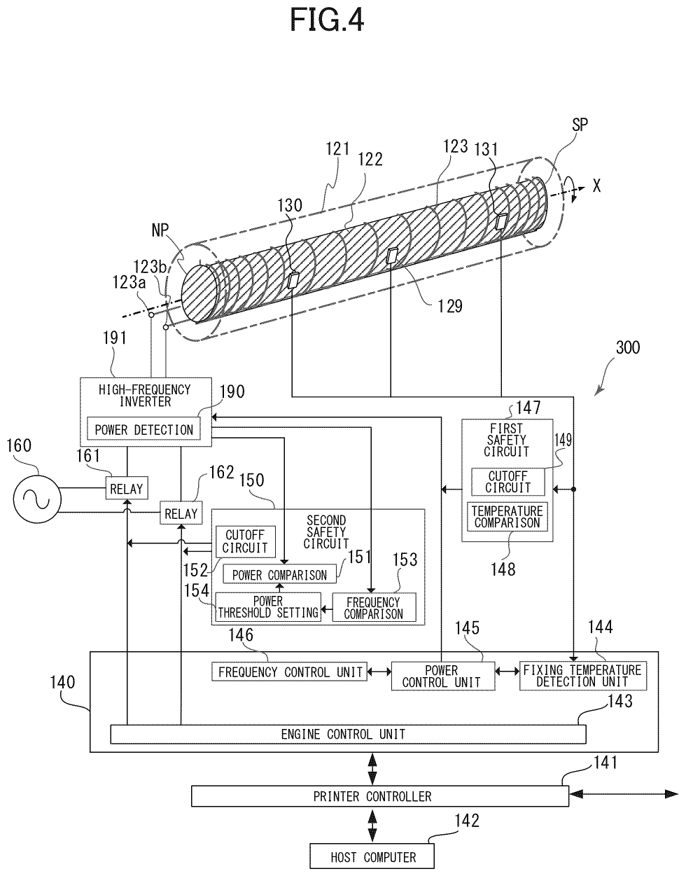

Next, an induced current generation mechanism of the heating unit 201 will be described. As illustrated in FIG. 4, alternating current (AC) power is supplied to a high-frequency inverter 191 from an external AC power supply 160 via relays 161 and 162. Here, the first relay 161 and the second relay 162 are provided on both sides of the AC power supply 160, respectively, but only the first relay 161 may be provided. The high-frequency inverter 191 includes a power detection circuit 190 that detects power input to the excitation coil 123. The power detection circuit 190 calculates the power input to the excitation coil 123 based on a current flowing through the excitation coil 123 and an AC voltage supplied from the AC power supply 160.

The magnetic core 122 serving as the magnetic core material is disposed to penetrate through the hollow portion of the fixing film 121 by a fixing unit (not illustrated), and guides lines of magnetic force of an AC magnetic field generated by the excitation coil 123 to the inside of the fixing film 121 to function as a member forming a passage (magnetic path) of the lines of magnetic force. In particular, the magnetic core 122 of the present embodiment is formed in a rod shape and forms the magnetic path that does not pass through the magnetic core 122 outside the excitation coil 123, thereby forming an open magnetic path. That is, the magnetic core 122 is a magnetic core material that is installed inside the fixing film 121 and forms the open magnetic path in the longitudinal direction of the magnetic core 122 (the longitudinal direction/axial direction of the fixing film 121). A material of the magnetic core 122 may be a ferromagnetic material formed of a material having a small hysteresis loss and a high relative permeability such as sintered ferrite, a ferrite resin, an amorphous alloy, or an oxide or alloy material having a high permeability such as permalloy. The excitation coil 123 is wound around the magnetic core 122 in a direction intersecting a rotation axis X. In other words, the excitation coil 123 is wound around the magnetic core 122 such that a spiral axis extends in the longitudinal direction of the magnetic core 122, and a high-frequency current flows through the excitation coil 123 by the high-frequency inverter 191 or the like via power supply contact portions 123a and 123b, thereby generating a magnetic flux.

The excitation coil 123 is formed by spirally winding a normal single conductive wire around the magnetic core 122 in the hollow portion of the fixing film 121. In other words, the excitation coil 123 is wound in the direction intersecting the rotation axis inside the fixing film 121. Therefore, when a high-frequency voltage is applied to the excitation coil 123 via the high-frequency inverter 191 and the power supply contact portions 123a and 123b, an AC current flows through the excitation coil 123, and an alternating magnetic flux can be generated in a direction parallel to the rotation axis of the fixing film 121. Although the excitation coil 123 has been described as a single conductive wire, the excitation coil 123 is not limited thereto and may be formed by integrating a plurality of conductive wires into one.

In addition, as a control mechanism 300 for temperature control of the heating unit 201, the control unit 31 (see FIG. 1) of the image forming apparatus 100 includes a CPU 140 serving as the computation unit or a control unit, and first and second safety circuits 147 and 150. The CPU 140 functions as an engine control unit 143, a fixing temperature detection unit 144, a power control unit 145, and a frequency control unit 146 for the temperature control of the heating unit 201.

A temperature signal of the first temperature detection element 129 provided to detect a temperature of a region (sheet passing region) through which the recording material P passes in a rotation axis direction of the fixing film 121 is input to the fixing temperature detection unit 144. Then, the high-frequency inverter 191 is controlled by the power control unit 145 and the frequency control unit 146 based on the temperature signal of the first temperature detection element 129, and an appropriate high-frequency voltage is applied to the power supply contact portions 123a and 123b. As a result, the fixing film 121 is induction-heated, and the temperature of the surface is maintained at or adjusted to (temperature control) the predetermined target temperature.

More specifically, the power control unit 145 controls a pulse period and a pulse-on time for applying the high-frequency voltage based on a detection result of the fixing temperature detection unit 144 and a frequency setting made by the frequency control unit 146, thereby performing power control of the high-frequency inverter 191. In FIG. 4, the engine control unit 143, the fixing temperature detection unit 144, the power control unit 145, and the frequency control unit 146 are all described as components included in the CPU 140, but the present disclosure is not limited to such a configuration, and the engine control unit 143, the fixing temperature detection unit 144, the power control unit 145, and the frequency control unit 146 may be implemented by different circuits, the computation unit, or the like.

Next, reception of image data and the like will be described. The control unit 31 includes a printer controller 141 that communicates with a host computer 142, and the printer controller 141 receives the image data from the host computer 142 and develops the received image data into information that can be printed by the image forming apparatus 100. In addition, the printer controller 141 simultaneously exchanges a signal and performs serial communication with the engine control unit 143.

The engine control unit 143 exchanges a signal with the printer controller 141 and further performs various controls of the image forming apparatus 100 through serial communication. The host computer 142 transfers the image data to the printer controller 141 and sets various print conditions such as a size of the recording material P in the printer controller 141 in response to a request from a user.

### Driving Frequency and Heat Generation Distribution

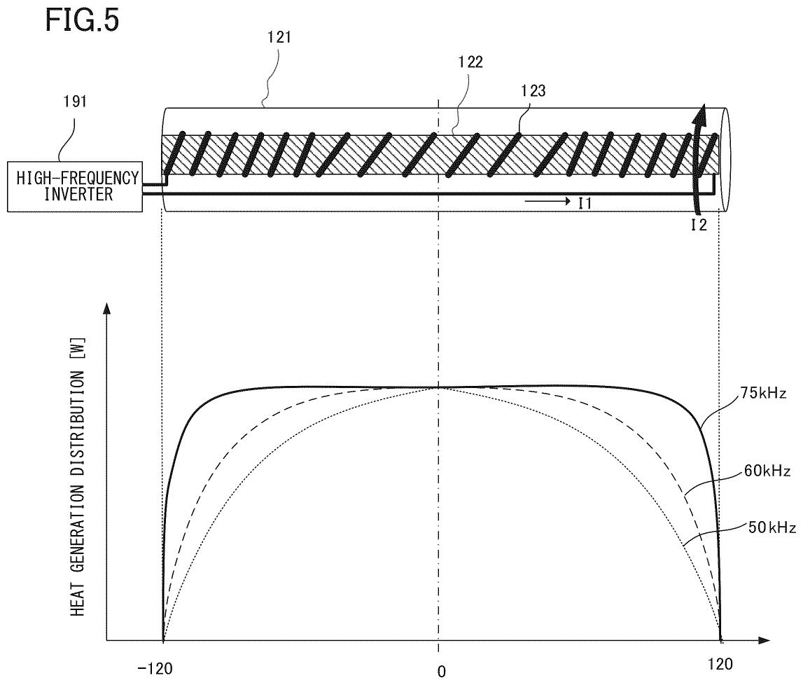

FIG. 5 is a diagram illustrating a characteristic in which output power changes depending on a driving frequency, and illustrates a heat generation distribution of the fixing film 121 in a case where a high-frequency voltage is applied from the high-frequency inverter 191 to the power supply contact portions 123a and 123b. Here, the heat generation layer 121a of the fixing film 121 is stainless steel having a thickness of 30 μm, a diameter of 30 mm, and a length of 220 mm. The magnetic core 122 is a ferrite core having a diameter of 12 mm, a length of 240 mm, and a relative permeability of 1800. The excitation coil 123 is a conductive wire wound with a winding pitch that is denser at end portion sides and looser at a central portion side. For example, the excitation coil 123 is wound 18 times around the magnetic core 122, and a winding interval is 10 mm at the end portions, 20 mm at the central portion, and 15 mm between the end portions and the central portion. When a current I1 flows through the excitation coil 123, an alternating magnetic field is formed inside the magnetic core 122, and a loop current I2 indicated by a dotted line flows in the entire region of the fixing film 121 in the longitudinal direction, whereby the fixing film 121 generates heat.

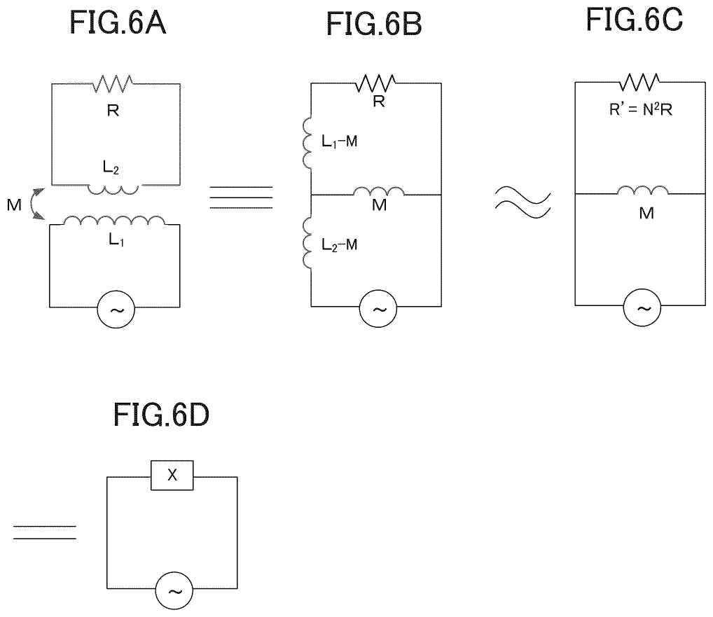

A relationship between the driving frequency and the heat generation will be briefly described below. FIGS. 6A to 6D illustrate equivalent circuits of the excitation coil 123 and the heat generation layer 121a of the fixing film 121. In FIG. 6A, L₁ represents an inductance of a primary winding, L₂ represents an inductance of a secondary winding, M represents a mutual inductance between the primary winding and the secondary winding, and R represents a resistance. The circuit diagram of FIG. 6A can be equivalently converted into the circuit diagram of FIG. 6B. It is assumed that the mutual inductance M is sufficiently large and L₁≈L₂≈M in order to consider a more simplified model. In this case, (L₁−M) and (L₂−M) become sufficiently small, so that the circuit can be approximated as illustrated in FIGS. 6B and 6C.

Here, the resistance will be described. In the circuit diagram of FIG. 6A, an impedance on a secondary side is the electric resistance R of the heat generation layer 121a in a circulating direction. In a transformer, the impedance on the secondary side is an equivalent resistance R′ that is N² times (N is a ratio of the number of turns of the transformer) when viewed from a primary side. Here, the ratio N of the number of turns of the transformer can be considered by regarding the heat generation layer 121a as one turn when the number of turns of the primary winding=the number of turns of the excitation coil 123 in the heat generation layer 121a. Therefore, R′=N²R can be considered, and the equivalent resistance R′ illustrated in FIG. 6C increases as the number of turns increases.

FIG. 6D defines a combined impedance X, which is further simplified. The combined impedance X is obtained as expressed in the following Formula (1).

$$Mathematica Formula 1$$

$$\frac{1}{X} = \frac{1}{R \text{?}} + \frac{1}{j ω M} \text{?} ( ω = 2 π f ) \qquad ( 1 )$$

$$\vert X \vert = \frac{1}{\sqrt{\text{?}}}$$

$$\text{?} \text{indicates text missing or illegible when filed}$$

Accordingly, the combined impedance X has frequency dependence on the term of (1/ωM)². This means that the inductance M as well as the resistance R′ contributes to the combined impedance, and that a load resistance has frequency dependence since a dimension of the impedance is [Ω].

When the number of turns of the coil per unit length varies depending on a position in the longitudinal direction in this manner, it is possible to form a substantially uniform heat generation distribution in the longitudinal direction according to frequency control of the high-frequency voltage (driving frequency control of the high-frequency inverter 191). As illustrated in FIG. 5, it can be seen that as the driving frequency decreases below 75 kHz, the less heat is generated at both ends of the fixing film, and as the driving frequency increases above 75 kHz, the more heat is generated at both ends of the fixing film.

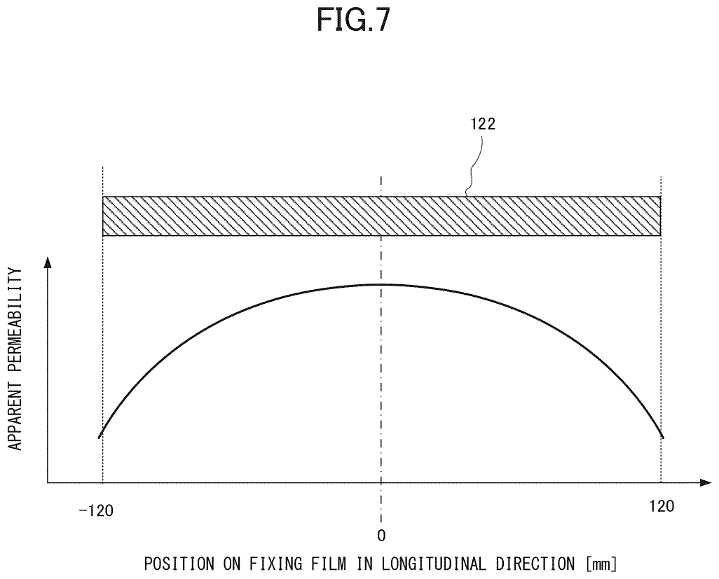

Next, the fact that “apparent permeability μ decreases at the end portion of the magnetic core” will be described. The graph of FIG. 7 is an explanatory diagram of a phenomenon in which the “apparent permeability μ” is lower at both end portions of the magnetic core 122 than at the central portion. The reason why such a phenomenon occurs will be described in detail below. In a magnetic field region where magnetization of an object is substantially proportional to an external magnetic field in a uniform magnetic field H, a magnetic flux density B in a space follows the following Formula (2).

$$Mathematical Formula 2$$

$$B = μ H \qquad ( 2 )$$

That is, placing a substance having a high permeability u in the magnetic field H can ideally result in the magnetic flux density B proportional to the permeability. In the present disclosure, such a space having a high magnetic flux density is utilized as the “magnetic path”. In particular, when forming the magnetic path, a closed magnetic path formed by connecting the magnetic path itself as a loop and an open magnetic path in which the magnetic path is disconnected by forming an open end or the like may be formed, and the present embodiment is characterized by using the open magnetic path.

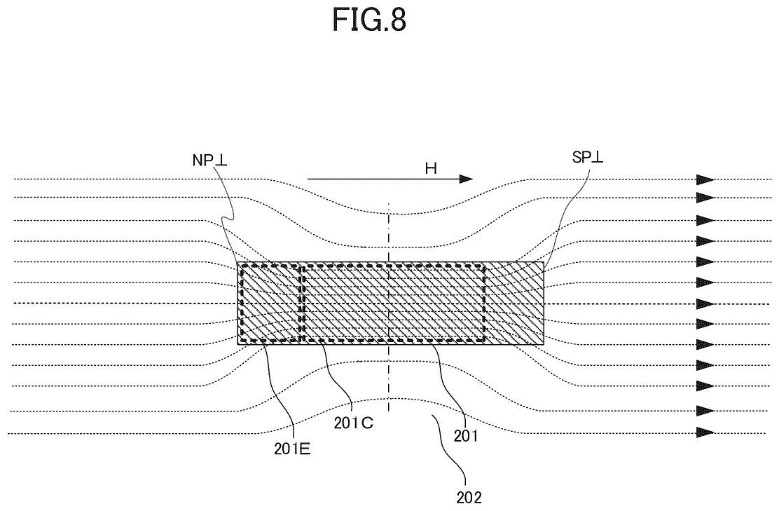

FIG. 8 illustrates a shape of the magnetic flux in a case where ferrite 201 and air 202 are placed in the uniform magnetic field H. The ferrite has the open magnetic path having boundary surfaces NP⊥ and SP⊥ perpendicular to the lines of magnetic force with respect to the air. In a case where the magnetic field H is generated in parallel to the longitudinal direction of the magnetic core 122, as illustrated in FIG. 8, the lines of magnetic force have a low density in the air and a high density at a central portion 201C of the magnetic core. Furthermore, the magnetic flux density is lower at an end portion 201E than at the central portion 201C of the magnetic core.

The reason why the magnetic flux density decreases at the end portions as described above is a boundary condition between the air and the ferrite. Since the magnetic flux density is continuous at the boundary surfaces NP⊥ and SP⊥ perpendicular to the lines of magnetic force, a magnetic flux density at an air portion that is in contact with the ferrite is high in the vicinity of the boundary surfaces, and a magnetic flux density at the end portion 201E of the ferrite that is in contact with the air is low. As a result, the magnetic flux density decreases at the end portion 201E of the ferrite. Since such a phenomenon appears as if the permeability at the end portion decreases as the magnetic flux density decreases, the expression “the apparent permeability decreases at the end portion of the magnetic core” is used in the description of the present embodiment. An equivalent inductance L from both ends of the coil is expressed by the following Formula (3).

$$Mathematical Formula 3$$

$$L = \frac{μ {N}^{2} S}{\text{?}} \qquad ( 3 )$$

$$\text{?} \text{indicates text missing or illegible when filed}$$

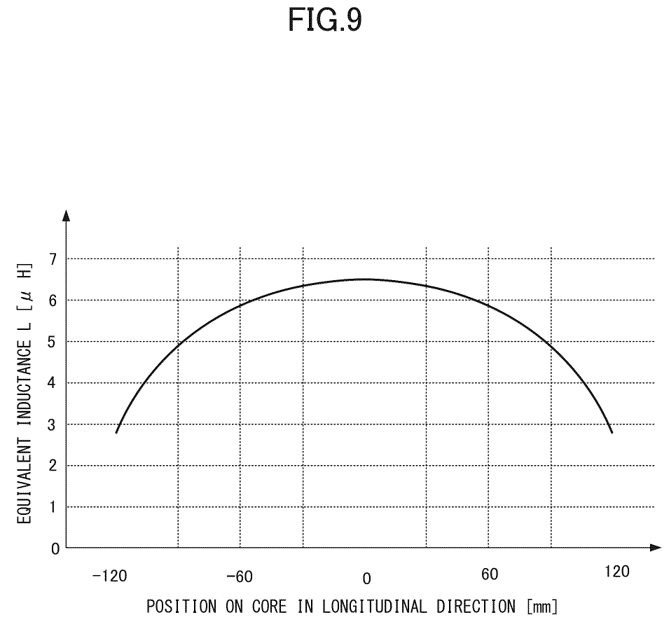

Here, μ represents the permeability of the magnetic core, N represents the number of turns of the coil, l represents the length of the coil, and S represents a cross-sectional area of the coil. Therefore, the equivalent inductance L also has a peak-shaped distribution as illustrated in FIG. 9 because “the apparent permeability decreases at the end portion of the magnetic core”.

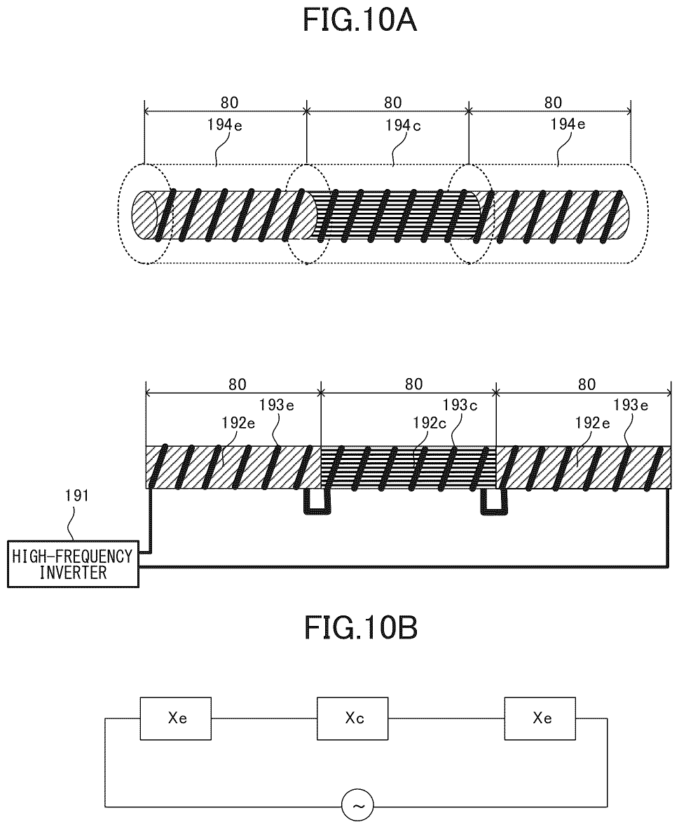

Next, it will be described that an effect of “changing a balance between the inductance and the resistance at the end portion and the central portion” can be obtained because “the number of turns of the coil is large at the end portion of the magnetic core and small at the central portion”. In the configuration, the apparent permeability and the number of turns have distributions in the longitudinal direction. In order to describe these with a simple model, description will be made using the configuration illustrated in FIG. 10A. FIG. 10A is a diagram obtained by dividing a configuration for induction heating according to the embodiment of the present disclosure into approximately three parts in the longitudinal direction. A longitudinal dimension is equally divided into three, and shapes and physical properties of both end portions are the same. The magnetic core is divided into end portions 192e (permeability μe) and a central portion 192c (permeability μc), and each longitudinal dimension is 80 mm.

The permeability of each of the cores 192e and 192c satisfies a relationship μe of the end portion<μc of the central portion, and for the sake of simplicity, it is assumed that there is no change in the apparent permeability of each of the magnetic cores 192e and 192c. As for the winding, an excitation coil 193e is wound Ne times around the magnetic core 192e, and an excitation coil 193c is wound Nc times around the magnetic core 192c. Here, a simple physical model will be considered. In FIG. 10A, fixing films 194e and 194c having the same shape and the same physical property are disposed in the heat generation layer 121a, and a loop resistance is Re=Rc (=R). Since the permeabilities of the magnetic cores 192e and 192c have a relationship μe<μc, the mutual inductance has a relationship Me<Mc. A further simplified equivalent circuit is illustrated in FIG. 10B. An equivalent resistance viewed from the primary side of each circuit is Ne²R at the end portion and Nc²R at the central portion. Therefore, combined impedances Xe and Xc are obtained as expressed in the following Formulas (4) and (5).

$$Mathematical Formula 4$$

$$[ Xe ] = \frac{1}{\sqrt{\text{?}}} \qquad ( 4 )$$

$$Mathematical Formula 5$$

$$[ Xc ] = \frac{1}{\sqrt{\text{?}}} \qquad ( 5 )$$

$$\text{?} \text{indicates text missing or illegible when filed}$$

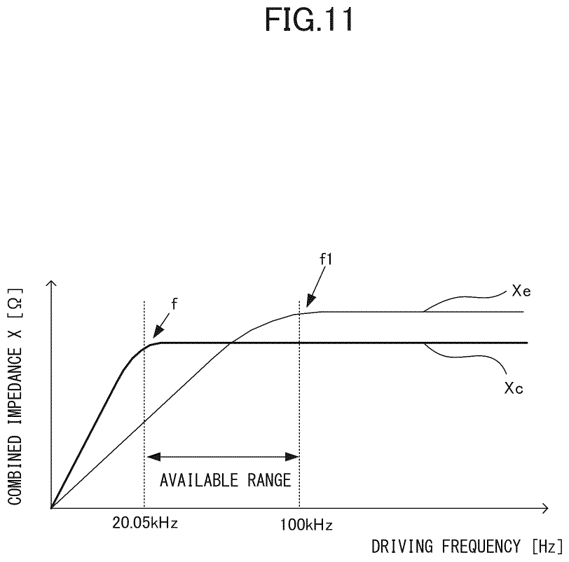

The combined impedance Xe and the combined impedance Xc have different frequency characteristics. The frequency characteristics of the combined impedance Xe and the combined impedance Xc are plotted on a graph as illustrated in FIG. 11. Behavior of the combined impedance Xc changes like a frequency filter. The combined impedance Xc monotonically increases when the combined impedance Xc is lower than a cutoff frequency f and does not change when the combined impedance Xc is higher than the cutoff frequency f. Such a phenomenon will be qualitatively described. When the frequency is low, the circuit responds like a series circuit. That is, an inductor approaches a short-circuit condition, causing a current to flow toward the inductor, which results in a low combined impedance. Conversely, when the frequency is high, the inductor behaves almost like an open circuit, causing a current to flow toward the resistance R, which results in a high combined impedance and no further change.

In a case where a constant voltage is applied to each circuit from the high-frequency inverter 191, a magnitude relationship of an amount of generated heat is determined by the combined impedance. Behavior of the combined impedance Xe also changes with a cutoff frequency f1 as a boundary similarly to the combined impedance Xc. However, the combined impedance Xe and the combined impedance Xc have different cutoff frequencies due to different equivalent resistances and different mutual inductances Me and Mc.

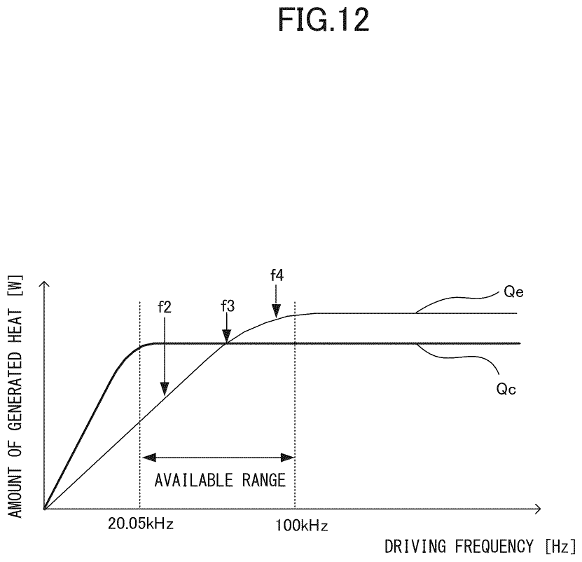

FIG. 12 illustrates the amount of generated heat when the same high-frequency voltage is supplied to the central portion and the end portion. Qc is the amount of generated heat at the central portion, Qe is the amount of generated heat at the end portion, and Qc and Qe show the same behavior as the change in the combined impedance. Control of the heat generation distribution of the fixing film 121 using such a phenomenon will be described. In a case where a frequency f3 is selected, the amount Qc of generated heat at the central portion and the amount Qe of generated heat at the end portion are the same as each other as illustrated in FIG. 12. As a result, the heat generation amounts at the central portion and the end portion are equal to each other in the longitudinal direction, and a flat distribution can be obtained. In a case where a frequency f2 is selected, the amount Qe of generated heat at the end portion is smaller than Qc as illustrated in FIG. 12. As a result, the amount of generated heat at the end portion is small in the longitudinal direction, and a peak-shaped distribution is obtained. On the other hand, for example, in a case where a frequency f4 is selected, the amount Qe of generated heat at the end portion is larger than Qc as illustrated in FIG. 12. As a result, a heat generation distribution in which both ends in the longitudinal direction are raised is obtained.

With such a mechanism, the heat generation distribution of the fixing film 121 can be controlled by changing the driving frequency of the high-frequency inverter 191. When used for heat generation distribution control of the fixing film 121, a variable range of the driving frequency may be, for example, a region of f2 to f3. This makes it possible to selectively use the flat distribution and the peak-shaped distribution. When a frequency band higher than f3 is used, a heat generation distribution in which the amount of generated heat at the end portion is larger can be obtained. The driving frequency changes according to the size of the recording material P and the temperature of the non-sheet passing region of the fixing film 121 by using such a feature. The non-sheet passing region is a region through which the recording material having a maximum size available in the apparatus passes but a recording material having a size smaller than the maximum size does not pass. When a large-sized recording material is subjected to fixing processing, the entire region of the fixing film 121 in the longitudinal direction is uniformly heated, and when a small-sized recording material is subjected to the fixing processing, the temperature of the end portion of the fixing film 121 is controlled to be lowered by lowering the driving frequency. As a result, it is possible to suppress the temperature rise in the non-sheet passing region when fixing the small-sized recording material.

### Safety Circuit

Next, the safety circuit 147 and 150 for preventing abnormal heat generation of the heating unit 201 will be described. As described above, the temperature control of the heating unit 201 is mainly performed by the CPU 140, and the CPU 140 detects a signal from the temperature detection element 129 and determines the input power based on a difference from a target fixing temperature. Limit input power (hereinafter, also referred to as limit input power of FW control) is set for the input power, and the CPU 140 controls the input power based on the power detected by the power detection circuit 190 to reduce the input power. Furthermore, the driving frequency of the high-frequency inverter 191 is determined by the frequency control unit 146 based on the size of paper to be printed and a temperature difference between the temperature detection element 129 at the central portion of the film and the temperature detection element 130 or the temperature detection element 131 at the end portion of the film.

As described above, the high-frequency inverter 191 is controlled mainly by the CPU 140 such that the fixing film 121 can appropriately generate heat. Here, when an abnormality occurs in the CPU 140 or sensors communicating with the CPU 140, there is a possibility that the fixing film 121 is overheated and reaches an abnormal temperature. Specifically, there is a case where a control program itself of the CPU 140 runs out of control, or a case where an output port included in a power control unit of the CPU 140 fails and a pulse width modulation (PWM) signal is continuously output to the high-frequency inverter 191. Alternatively, there is a case where the power detection circuit 190 fails and a value lower than the actual input power is transmitted to the CPU 140, or a case where a circuit of a reception unit with which the CPU 140 receives signals from the temperature detection elements 129 to 131 and the power detection circuit 190 fails.

Therefore, as illustrated in FIG. 4, the control mechanism 300 that performs the temperature control of the heating unit 201 includes the first and second safety circuits 147 and 150. The first safety circuit 147 is a unit for preventing overheating of the fixing film 121 based on a surface temperature of the fixing film 121. That is, the first safety circuit 147 is configured to detect abnormal heat generation of the fixing film 121 and cut off energization in the event of the abnormal heat generation by using the temperature detection elements 129, 130, and 131 in addition to a thermoswitch or a thermal fuse (not illustrated). That is, in the present embodiment, the first safety circuit 147 is a power cutoff unit (second power cutoff unit) that cuts off the supply of the power from the inverter 191 to the excitation coil 123 regardless of a control state of the high-frequency inverter 191 by the CPU 140 in a case where the temperatures detected by temperature detection elements 129, 130, and 131 exceed a threshold.

Specifically, the first safety circuit 147 includes a temperature comparison unit 148 and a first forced power cutoff circuit 149. Detection signals of the temperature detection elements 129, 130, and 131 are input to the temperature comparison unit 148, and when the temperature comparison unit 148 determines that any one of the temperature detection elements 129, 130, and 131 has exceeded the abnormal temperature, the first forced power cutoff circuit 149 is operated. When the first forced power cutoff circuit 149 is operated, a signal (for example, the PWM signal) output from the power control unit 145 to drive the high-frequency inverter 191 is forcibly cut off (turned off). A configuration of the first forced power cutoff circuit 149 is not limited thereto and may be any configuration as long as abnormal heat generation can be stopped.

In this way, when the first safety circuit 147 is provided, abnormal heat generation of the fixing film 121 can be prevented based on the temperatures detected by the temperature detection elements 129, 130, and 131. However, in the case of the heating unit 201 that heats the fixing film 121 while changing the driving frequency of the high-frequency inverter 191 as in the present embodiment, there are the following concerns.

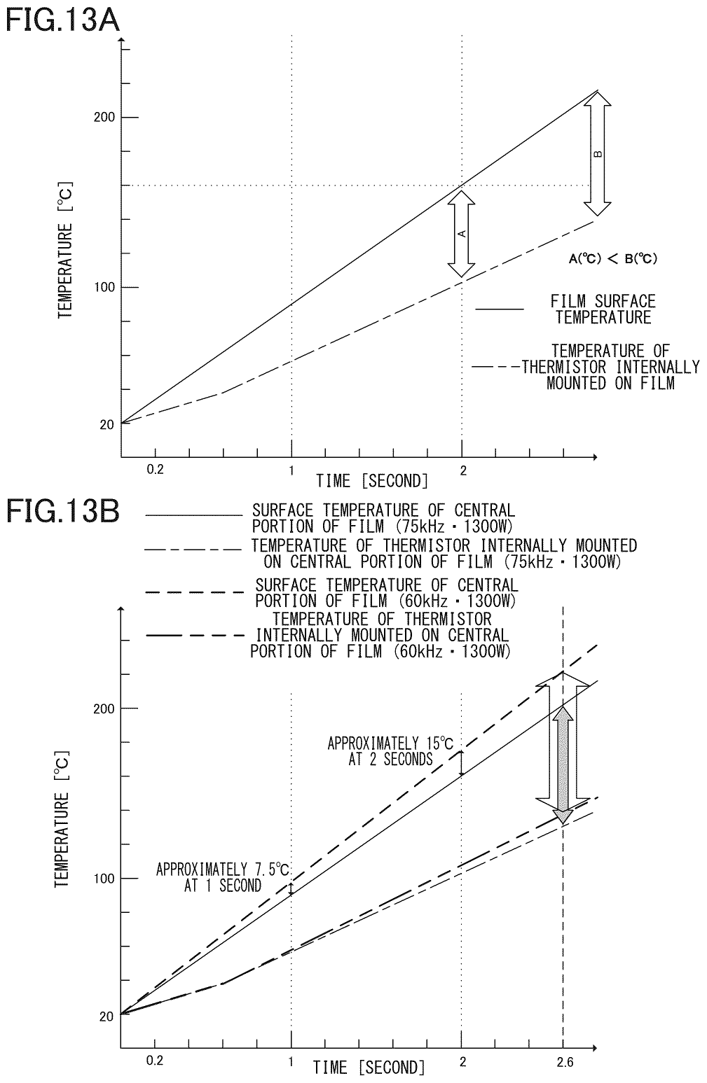

First, the fixing film 121 that comes into contact with the toner image on the recording material is thin and has a small heat capacity. Since the heat capacity of the fixing film 121 is small, in a case where an abnormality in which the fixing film 121 does not rotate occurs, the heat taken by the pressure roller 128 and the like is reduced, which results in a remarkably fast temperature rise of the fixing film 121. For example, FIGS. 13A and 13B illustrate an example thereof.

FIG. 13A is a diagram illustrating transitions of an actual temperature of the surface of the fixing film and a temperature of the internally mounted thermistor that is internally mounted on the fixing film. A horizontal axis represents a time from the input of the power, a vertical axis represents a temperature, and an example of the transitions of the film surface temperature and the temperature of the internally mounted thermistor is shown. As illustrated in FIG. 13A, when the input of the power starts in a state in which the film does not rotate, the film surface temperature and the detected temperature of the internally mounted thermistor increase with time. Therefore, for example, when a failure of a gear, a CPU, or the like occurs and an abnormal state in which the film does not rotate occurs, there is a possibility that the film surface temperature reaches the abnormal temperature before the detected temperature of the thermistor serving as the temperature detection element reaches a print temperature.

Second, in the electromagnetic induction heating type heating unit 201 as in the present embodiment, the heat generation distribution of the fixing film 121 in the longitudinal direction changes according to the driving frequency of the high-frequency inverter 191 as illustrated in FIG. 5. That is, even if the input power from the high-frequency inverter 191 to the excitation coil 123 is the same, when the driving frequency of the high-frequency inverter 191 is low, the amount of generated heat at the central portion of the fixing film 121 increases as the amount of generated heat at the end portion of the fixing film 121 decreases. That is, excessive power is easily locally input to the central portion of the fixing film 121.

FIG. 13B is a diagram illustrating transitions of a surface temperature of the central portion of the fixing film and a temperature of the thermistor internally mounted on the central portion at each driving frequency of the high-frequency inverter. A solid line indicates a transition of the surface temperature of the central portion of the film when power of 1300 W is input at a driving frequency of 75 kHz, and a dotted line indicates a transition of the surface temperature of the central portion of the film when power of 1300 W is input at a driving frequency of 60 kHz. Lowering the driving frequency results in a steep temperature gradient at the central portion of the film, and thus, a higher temperature is reached even with the same driving time.

Meanwhile, the transition of the temperature of the internally mounted thermistor at the central portion of the film is a transition of the temperature of the internally mounted thermistor when power of 1300 W is input at a driving frequency of 75 kHz as indicated by a one-dot chain line. In addition, a two-dot chain line indicates a transition of the temperature of the internally mounted thermistor when power of 1300 W is input at a driving frequency of 60 kHz. Although a temperature gradient of the internally mounted thermistor is slightly steeper when the driving frequency is lowered, a temperature change is more gradual as compared with the change in surface temperature, and it can thus be seen that the internally mounted thermistor cannot follow the surface temperature. In other words, even with the same input power, the temperature of the central portion of the fixing film increases within a shorter time at a lower driving frequency, but an abnormal temperature detection operation using the internally mounted thermistor is delayed. Therefore, as the driving frequency is lowered, the temperature at the central portion of the film easily reaches the abnormal temperature.

Therefore, in the present embodiment, the second safety circuit 150 is provided in addition to the first safety circuit 147 so that an abnormally high temperature detection operation is not delayed. The second safety circuit 150 includes a power comparison unit 151, a second forced power cutoff circuit 152, a frequency comparison unit 153, and a power threshold setting unit 154. The power comparison unit 151 and the frequency comparison unit 153 are connected to the high-frequency inverter 191, and a detection signal of the power detection circuit 190 is input to the power comparison unit 151. In addition, the frequency comparison unit 153 can detect the driving frequency of the high-frequency inverter 191.

Further, the second forced power cutoff circuit 152 is configured to forcibly turn off (cut off) the first relay 161 and the second relay 162 regardless of an instruction from the engine control unit 143 when the circuit is operated. Similarly to the first forced power cutoff circuit 149, means by which the second forced power cutoff circuit 152 is turned off may have any configuration as long as abnormal heat generation can be stopped. For example, a signal from the power control unit 145 may be cut off.

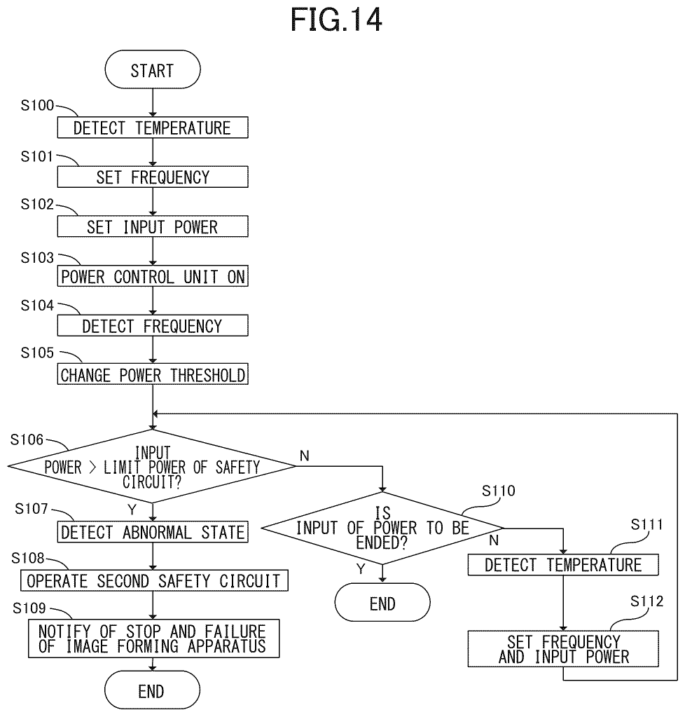

Next, an operation of the second safety circuit 150 will be described based on the flowchart of FIG. 14. When a print job is input from the host computer 142 to the printer controller 141, the temperature control of the heating unit 201 according to the input print job starts. Then, the CPU 140 functions as the fixing temperature detection unit 144 and detects the surface temperature of the fixing film 121 based on the temperature signal of the temperature detection element 129 (step S100 in FIG. 14).

Next, the CPU 140 functions as the frequency control unit 146 capable of changing the driving frequency, and sets the driving frequency of the high-frequency inverter 191 based on the detection results of the temperature detection elements 129, 130, and 131 and the print job (step S101).

Once the driving frequency is set, the CPU 140 functions as the power control unit 145 and sets the input power according to a difference between the current temperature and the target fixing temperature, and the driving frequency (step S102). For a set value of the input power set by the CPU 140, the limit input power of the FW control is set as an upper limit value as described above, and the CPU 140 sets a value (target value) of the input power within the limit input power of the FW control by using the control program.

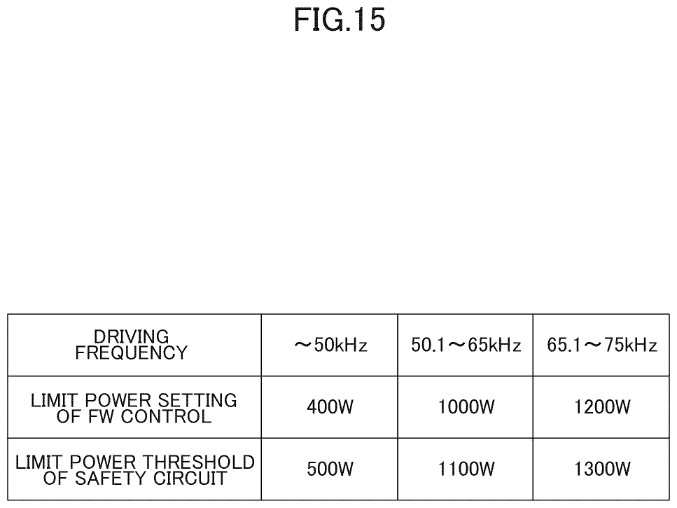

In the present embodiment, the limit input power of the FW control is set as illustrated in the table of FIG. 15, and the limit input power is determined for each driving frequency. In addition, as can be seen from FIG. 15, the limit input power of the FW control is set such that, as the driving frequency decreases below 65.1 kHz, the less power can be input, and as the driving frequency increases above 75 kHz, the less power can be input.

Then, when the power input to the excitation coil 123 is determined, the CPU 140 serving as the power control unit 145 outputs a control signal to the high-frequency inverter 191 and controls the high-frequency inverter 191 at the set driving frequency (step S103). When the control signal is input to the high-frequency inverter 191, a voltage according to the control signal is applied to the excitation coil 123, a current flows through the excitation coil 123, and the fixing film 121 is induction-heated.

When the high-frequency inverter 191 is driven, the frequency comparison unit 153 of the second safety circuit 150 functions as a frequency detection unit and detects the driving frequency of the high-frequency inverter 191 at that time (step S104). Then, when the driving frequency of the high-frequency inverter 191 is detected, the second safety circuit 150 switches a setting of the power threshold setting unit 154 to a setting corresponding to a value of the driving frequency of the high-frequency inverter 191 according to the detection result (step S105). That is, a power threshold at which the second forced power cutoff circuit 152 is operated is set in the power threshold setting unit 154. As illustrated as a limit power threshold of the safety circuit in FIG. 15, a value of the power threshold is set for each driving frequency of the high-frequency inverter 191, and the power threshold of the power threshold setting unit 154 is set to a power threshold having a value corresponding to the driving frequency detected by the frequency comparison unit 153.

More specifically, the limit power threshold of the safety circuit is larger than the set limit input power of the FW control, which is the upper limit value of the input power setting settable by the CPU 140 described above, at the same driving frequency. In addition, as the value of the driving frequency decreases below 65.1 kHz, the value of the power threshold decreases, and as the value of the driving frequency increases above 75 kHz, the power threshold decreases.

Specifically, in the present embodiment, in the case of a driving frequency of 65.1 kHz to 75 kHz, which corresponds to a uniform heat generation range in which the heat generation distribution of the fixing film 121 has a small difference between the end portion and the central portion in the longitudinal direction, the power threshold is set to 1300 W. In the case of a driving frequency of 50.1 kHz to 65 kHz, the power threshold is set to 1100 W. Furthermore, in a case where a driving frequency at which the amount of generated heat at the central portion of the fixing film 121 is larger than the amount of generated heat at the end portion is 50 kHz or less, the power threshold is set to 500 W. That is, the second safety circuit 150 serving as the power cutoff unit sets the power threshold to a first value in a case where the driving frequency of the high-frequency inverter 191 is a first driving frequency (for example, the driving frequency of 65.1 kHz to 75 kHz). The second safety circuit 150 sets the power threshold to a second value smaller than the first value in a case where the driving frequency of the high-frequency inverter 191 is a second driving frequency (for example, the driving frequency of 50 kHz or less) lower than the first driving frequency.

When the setting of the power threshold is completed, the power comparison unit 151 detects the power input to the excitation coil 123 by the high-frequency inverter 191 based on the detection signal from the power detection circuit 190, and determines whether or not the detected input power exceeds the power threshold (step S106). The power comparison unit 151 may detect the power input to the excitation coil 123 by any method. For example, the power detection circuit 190 may be configured as a current detection circuit that detects a current flowing through the excitation coil 123, and the input power may be estimated based on a magnitude of the current detected by the current detection circuit.

Here, in a case where the power comparison unit 151 has detected the input power larger than the power threshold (Yes in S106), an abnormal state is detected (step S107), and the power comparison unit 151 operates the second forced power cutoff circuit 152 (step S108). When the second forced power cutoff circuit 152 is operated, the relays 161 and 162 are turned off as described above, the power is not supplied from the AC power supply 160 to the high-frequency inverter 191, and the heat generation of the fixing film 121 is forcibly stopped.

When the abnormal state is detected, the CPU 140 emergently stops a printing operation of the image forming apparatus 100, displays a failure on a display panel (not illustrated), and ends the processing (step S109).

On the other hand, in a case where the input power does not exceed the power threshold in step S106 (No in step S106), the CPU 140 determines whether or not to continue the input of the power to continue the printing operation (step S110).

In a case where it is determined to continue the input of the power (No in step S110), the CPU 140 detects temperature information of the fixing film 121 after a predetermined time elapses (step S111). Then, the driving frequency and the input power are reset based on the detected temperature information (S112). When the resetting ends, the processing returns to S106, and steps S106 and S110 to S112 are repeated until the input of the power ends (Yes in step S110). Also in a case where the recording material conveyed during the printing operation is jammed, the printing operation is emergently stopped, and the CPU 140 determines to stop the input of the power and ends the processing (Yes in step S110).

As described above, in the present embodiment, when abnormal power is supplied, the heat generation of the fixing film 121 is forcibly stopped by the second safety circuit 150 based on the power input to the excitation coil 123. That is, in the present embodiment, the second safety circuit is a power cutoff unit (first power cutoff unit) that cuts off the supply of the power from the high-frequency inverter 191 to the excitation coil 123 regardless of the control state of the high-frequency inverter 191 by the CPU 140 in a case where the power input from the high-frequency inverter 191 to the excitation coil 123 exceeds the threshold. Therefore, heating of the fixing film 121 having a small heat capacity and a high temperature rise rate can also be stopped at an appropriate timing. In particular, the lower the driving frequency, the smaller the power threshold is set even in the induction heating type heating unit 201 in which the power tends to be concentrated at the central portion when the driving frequency of the high-frequency inverter 191 is low, and the central portion is thus easily heated. Therefore, it is possible to prevent the temperature of the central portion of the fixing film 121 from being locally increased to the abnormal temperature.

Then, since an abnormal temperature rise of the fixing film 121 can be appropriately prevented, it is possible to prevent the temperature of the fixing film 121 from becoming very high, which causes damage to peripheral members, due to a delay in detection of overheating.

In the present embodiment, not only the power threshold of the second safety circuit but also the value of the limit input power set by the control program of the CPU 140 is similarly switched according to the driving frequency. Therefore, in a case where a driving frequency at which a large amount of power is required to raise the temperature of the fixing film 121 to the target temperature is high, the value of the power input to the excitation coil 123 can be set high. As a result, the temperature of the fixing film 121 can be quickly raised to the target temperature, and a printing speed of the image forming apparatus 100 does not decrease. That is, the image forming apparatus 100 according to the present embodiment can achieve both high-speed printing and safety for minimizing damage to the apparatus due to heat generation.

When the driving frequency decreases, the upper limit value of the limit input power set by the control program of the CPU 140 also decreases. Therefore, even in a case where a driving frequency at which the amount of generated heat at the central portion of the film tends to be large is low, the temperature rise at the central portion of the film can be moderated, and the first safety circuit 147 can work before the peripheral members are damaged.

In the above-described embodiment, only a case where the driving frequency is up to 75 kHz is considered, but for example, a case where the driving frequency is higher than 75 kHz may also be considered. As described above, in a case where the driving frequency is higher than the frequency f3 (for example, 75 kHz), a heat generation distribution in which the temperature of the end portion is higher than that of the central portion of the fixing film 121 is obtained. Therefore, in such a case, in consideration of the temperature rise of the end portions of the fixing film 121, the power threshold of the second safety circuit 150 may be set lower than that in the case of a frequency at which a heat generation distribution at the central portion and the end portions is substantially uniform.

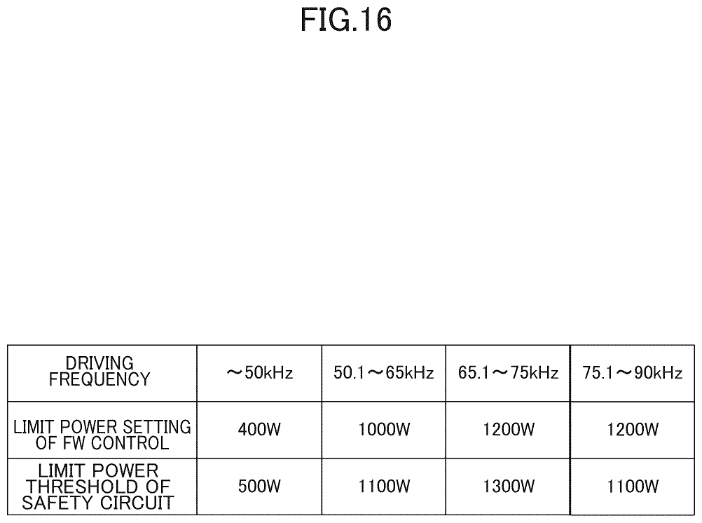

For example, as illustrated in FIG. 16, in a case where the driving frequency of the high-frequency inverter 191 is 75.1 kHz to 90 kHz, the power threshold of the second safety circuit 150 may be set to 1100 W which is lower than that in a case where the driving frequency of the high-frequency inverter 191 is 65.1 kHz to 75.1 kHz. In other words, the second safety circuit 150 sets the power threshold to the first value (for example, 1300 W) in a case where the driving frequency of the high-frequency inverter 191 is the first driving frequency (for example, 75.1 kHz), and sets the power threshold to a third value (for example, 1100 W) smaller than the first value in a case where the driving frequency of the high-frequency inverter 191 is a third driving frequency (for example, 90 kHz) higher than the first driving frequency.

Furthermore, in the above-described embodiment, the limit input power is lowered to 500 W in a case where the driving frequency is 50 kHz or less. However, for example, in a case where a control range of the driving frequency is set to, for example, a range of 50 kHz to 75 kHz, when the driving frequency deviates from the control range of the driving frequency, the CPU 140 may determine that an abnormality has occurred and lower the power threshold to 0 W. As a result, the second forced power cutoff circuit 152 is forcibly operated, and abnormal heat generation can be prevented.

### Second Embodiment

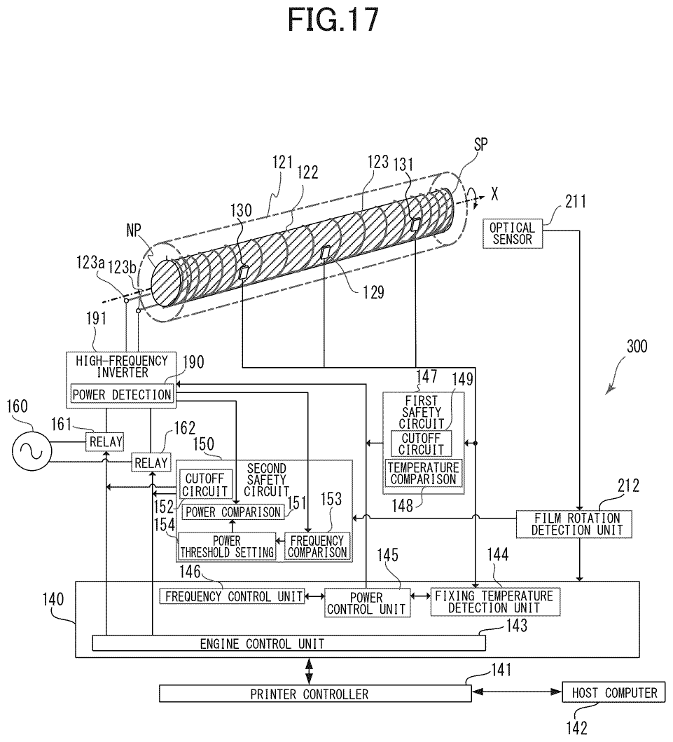

Next, a second embodiment will be described with reference to FIGS. 17 to 20. The present embodiment is different from the first embodiment described above in that a power threshold of a second safety circuit 150 is switched in consideration of a rotation state of a fixing film. Therefore, in the following description, only a configuration different from that of the first embodiment will be described, and description of other configurations will be omitted with the same reference numerals applied.

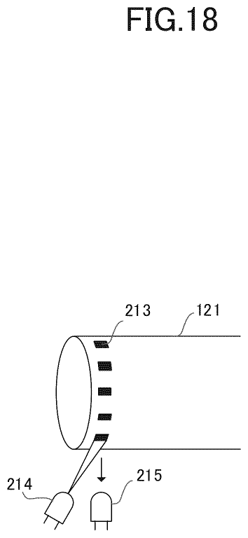

As illustrated in FIG. 17, an image forming apparatus 100 includes an optical sensor 211 and a film rotation detection unit 212 in order to detect rotation of a fixing film 121. In addition, as illustrated in FIG. 18, detection marks 213 for rotation detection arranged at equal intervals in a circumferential direction in a color different from other portions are provided on an outer peripheral surface on one end portion side of the fixing film 121. For example, in the present embodiment, the detection marks 213 each having a size of 3 mm square in black are arranged on the outer peripheral surface of the fixing film 121. When the recording material is wound around the fixing film 121 due to an accidental conveyance failure, the detection marks 213 cannot be detected, and thus, it is desirable that the detection marks 213 are positioned outside (end portion side) an area where the sheet is conveyed.

The above-described optical sensor 211 includes a light emitting element 214 and a light receiving element 215 and is disposed at a position where the optical sensor 211 can detect the detection marks 213. The light emitting element 214 and the light receiving element 215 are configured such that light emitted from the light emitting element 214 is reflected by the fixing film 121 and detected by the light receiving element 215. An intensity of the reflected light periodically changes by the rotation of the fixing film 121, and the optical sensor 211 converts the reflected light into an electric signal and outputs the electric signal to the film rotation detection unit 212.

The film rotation detection unit 212 determines that the fixing film 121 is rotating when the change in the intensity of the reflected light is large, and determines that the fixing film 121 is stopped in a case where there is almost no change in the intensity. In the present embodiment, a configuration in which film rotation detection is performed using the optical sensor 211 has been described, but a rotation detection configuration for the fixing film 121 is not limited to such a configuration, and may be any configuration.

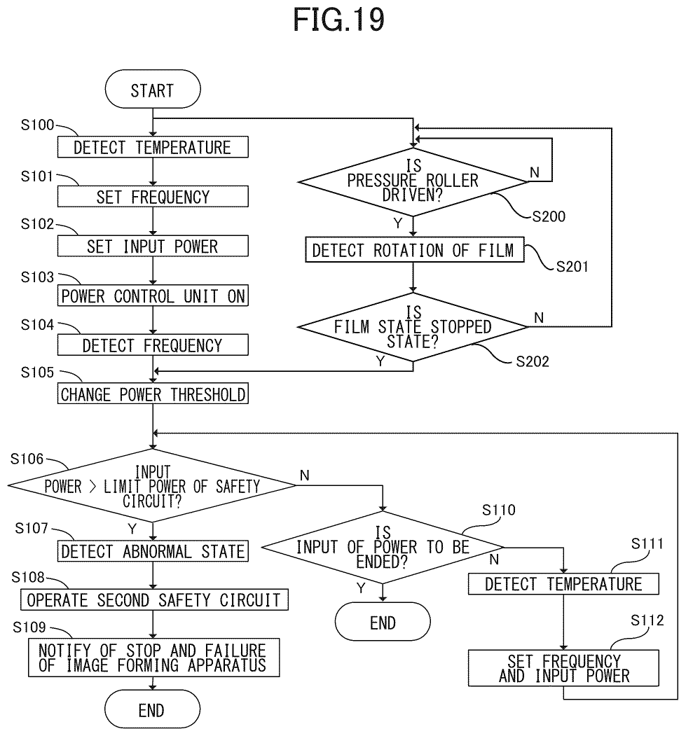

The film rotation detection unit 212 transmits a detection result to the second safety circuit 150, and the second safety circuit 150 sets a threshold of limit input power by using a power threshold setting unit 154 in consideration of a driving frequency and a rotation/stop state of the fixing film 121. Hereinafter, an operation of the second safety circuit 150 in the present embodiment will be described with reference to the flowchart of FIG. 19. The flowchart of FIG. 19 is different from the flowchart of FIG. 14 in operations of steps S200 to S202. Therefore, in the following description, steps S200 to S202 will be mainly described, and description of other steps will be omitted.

When a print job is input from a host computer 142, a CPU 140 checks whether or not a pressure roller 128 is driven in parallel with step S100 (step S200). In a case where the pressure roller 128 is driven (Yes in step S200), the film rotation detection unit 212 detects the rotation of the fixing film 121 based on a detection signal from the optical sensor 211 (step S201).

When the rotation of the fixing film 121 is detected, the CPU 140 determines whether or not the fixing film 121 is stopped based on the detection result of the film rotation detection unit 212 (step S202). Then, in a case where it is determined that the fixing film 121 is rotating (No in step S202), the CPU 140 returns to step S200. In a case where it is determined that the fixing film 121 is stopped (Yes in step S202), the power threshold of the second safety circuit 150 is set in consideration of the stop state of the fixing film 121 (step S105).

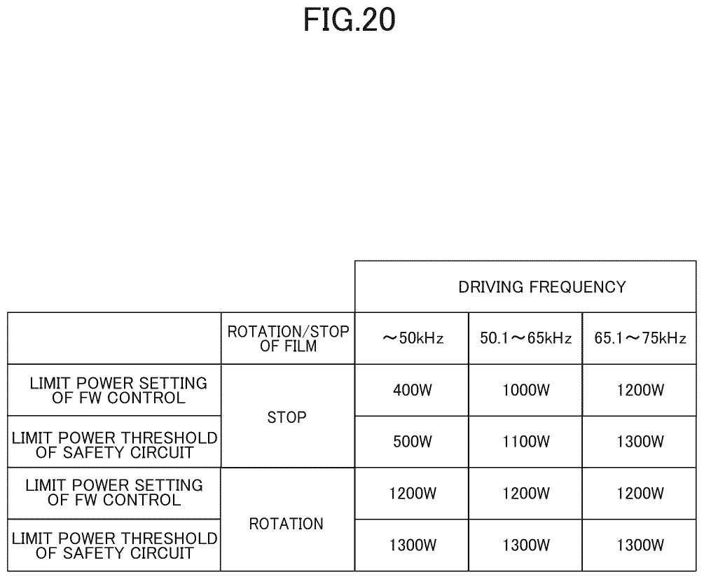

In the present embodiment, as illustrated in FIG. 20, a limit input power setting of FW control and a limit power threshold of the second safety circuit 150 are set to be different depending on whether or not the fixing film 121 is rotating. In a case where the fixing film 121 is stopped, the limit input power setting of the FW control and the limit power threshold of the second safety circuit 150 are set similarly to those in the first embodiment. Specifically, in a case where the driving frequency is 65.1 kHz to 75 kHz, the limit power threshold of the second safety circuit 150 is set to 1300 W. Similarly, in a case where the driving frequency is 50.1 kHz to 65 kHz, the limit power threshold of the second safety circuit 150 is set to 1100 W. In a case where the driving frequency is 50 kHz or less, the limit power threshold of the second safety circuit 150 is set to 500 W. Accordingly, the second safety circuit 150 can work faster than a first safety circuit 147 in a state in which the rotation of the fixing film 121 is stopped.

On the other hand, in a case where the fixing film 121 is in a rotating state, apparent heat capacity increases as heat is easily taken by the pressure roller 128 or the like, and thus followability of temperatures detected by temperature detection elements 129, 130, and 131 is increased. Therefore, a difference between the detected temperatures of the temperature detection elements 129, 130, and 131 and an actual surface temperature of the fixing film 121 becomes small. Therefore, if the fixing film 121 is in a rotating state, there is a low possibility that detection of abnormal heat generation of a heating unit 201 is delayed and the operation of the first safety circuit 147 is delayed. Therefore, the abnormal heat generation can be stopped even with only the first safety circuit 147 before the temperature of the fixing film 121 reaches an abnormal temperature.

For the reason described above, in the present embodiment, the threshold of the limit input power is not switched according to the driving frequency during the rotation of the fixing film 121. Specifically, the threshold is set to 1300 W regardless of the driving frequency. 1300 W is the highest threshold of the limit input power when the fixing film 121 is stopped. Further, in the present embodiment, the threshold of the limit input power is not switched, but the threshold of the limit input power may decrease as the driving frequency decreases. Even in this case, the threshold of the limit input power when the fixing film 121 is rotating is set to be equal to or more than the threshold of the limit input power when the fixing film 121 is stopped.

As described above, in the present embodiment, the threshold of the limit input power of the safety circuit is switched in consideration of two elements, the rotation state of the fixing film 121 and the driving frequency. Therefore, it is possible to prevent a temperature of a central portion of the film from locally rising to the abnormal temperature and damaging peripheral members of the fixing film 121. Further, if the fixing film 121 is rotating, the input of the power can be performed without reducing the input power, and thus, printing can be performed for various paper sizes without reducing a printing speed.

### Third Embodiment

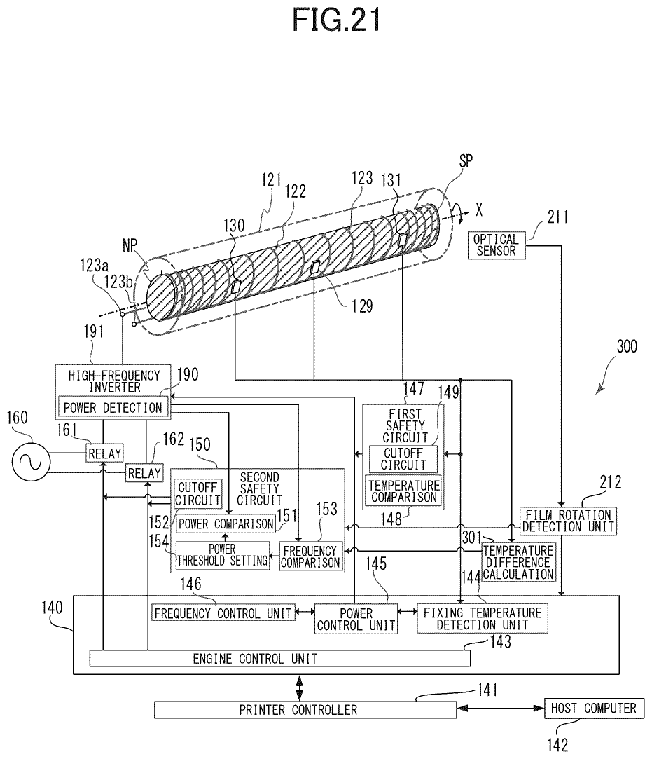

Next, a third embodiment will be described with reference to FIGS. 21 to 23A and 23B. The present embodiment is different from the second embodiment described above in that a threshold of a limit input power of a second safety circuit 150 is switched according to a temperature difference between a central portion and an end portion of a fixing film 121. Therefore, in the following description, only a configuration different from that of the second embodiment will be described, and description of other configurations will be omitted with the same reference numerals applied.

As described above, a magnitude relationship of an amount of generated heat of the fixing film 121 depends on a combined impedance. As expressed by Formula (4) or Formula (5), the combined impedance is affected by, for example, an electric resistance value R of a heat generation layer 121a in a circulating direction. Meanwhile, since the fixing film 121 has a resistance value variation of several % due to a manufacturing variation, the combined impedance varies even at the same frequency, and a temperature distribution in a longitudinal direction naturally varies.

In the present embodiment, in order to absorb such a variation, a temperature distribution for each fixing film is estimated from detection results of two temperature detection elements, and it is determined whether or not to change the threshold of the limit input power.

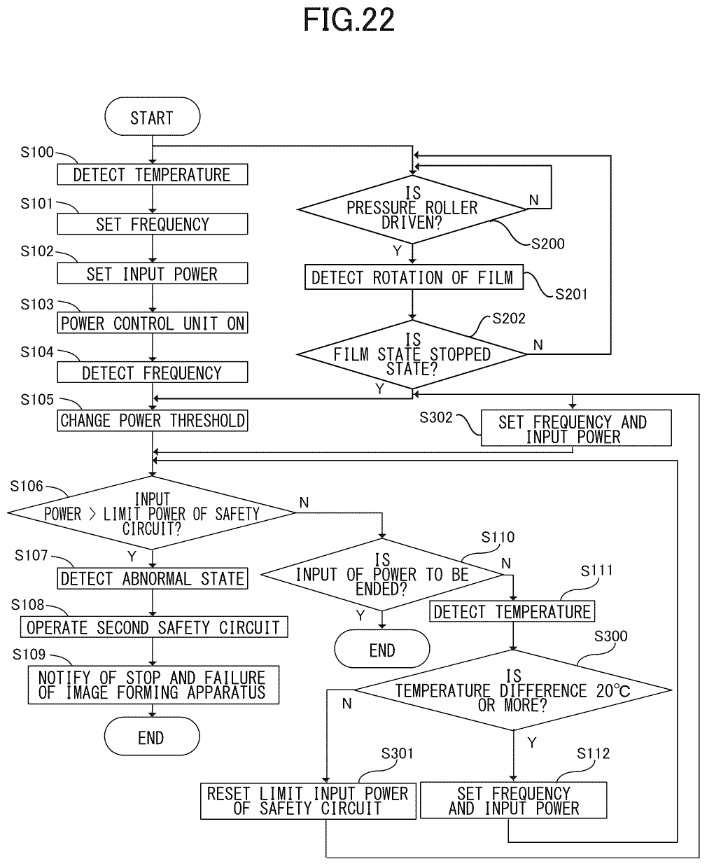

As illustrated in FIG. 21, in the present embodiment, a control mechanism 300 includes a temperature difference calculation unit 301 that calculates a temperature difference between a temperature detection element 129 and a temperature detection element 130 or a temperature detection element 131. Hereinafter, an operation of the second safety circuit 150 according to the present embodiment will be described with reference to the flowchart of FIG. 22. The flowchart of FIG. 22 is different from the flowchart of FIG. 19 in operations of steps S300 to S301. Therefore, in the following description, steps S300 to S301 will be mainly described, and description of other steps will be omitted.

When it is determined in step S110 to continue input of power (No in step S110), a surface temperature of the fixing film 121 is detected again using the temperature detection elements 129, 130, and 131 in S111.

When the surface temperature of the fixing film 121 is detected again, the temperature difference calculation unit 301 obtains the temperature difference between the central portion and the end portion of the film, and determines whether or not the temperature difference between the central portion and the end portion of the fixing film 121 is 20° C. or more (step S300).

Here, in a case where the temperature difference between the central portion and the end portion of the fixing film 121 is not 20° C. or more (No in step S300), a heat generation distribution of the fixing film 121 does not match a reference (designed) heat generation distribution in terms of central concentration. In this case, it can be seen that a heating unit 201 in this case hardly causes abnormal heat generation at the central portion of the fixing film 121 even in a case where a driving frequency of a high-frequency inverter 191 is low due to an influence of a component variation and the like.

Therefore, in a case where the temperature difference between the central portion and the end portion of the fixing film 121 is not 20° C. or more, a CPU 140 resets the threshold of the limit input power of the second safety circuit 150 (step S301) and proceeds to step S105. At the same time, similarly to step S112, the CPU 140 resets the driving frequency and a value of input power of the high-frequency inverter 191 based on temperature information.

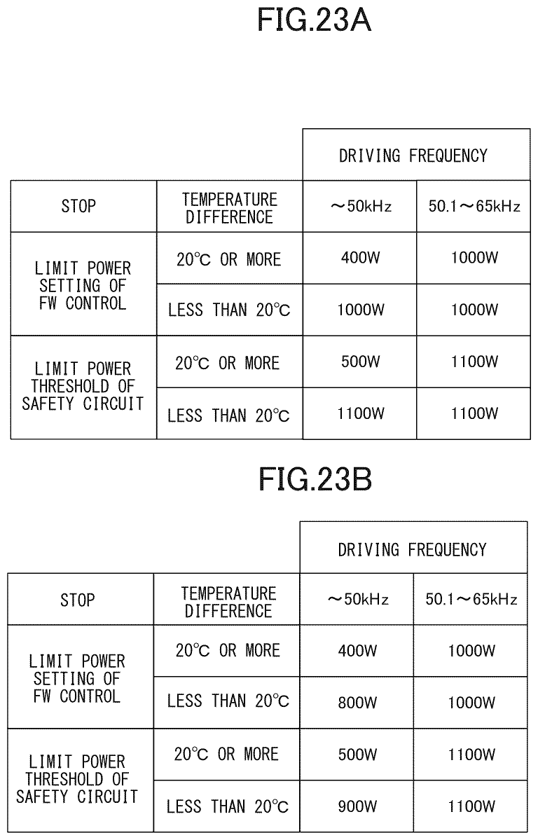

In step S105 described above, for example, in a case where the fixing film 121 is in a stopped state, in the present embodiment, the threshold of the limit input power is reset according to the table of FIG. 23A. More specifically, as illustrated in FIG. 23B, in a case where the temperature difference between the central portion and the end portion of the fixing film 121 is 20° C. or more, a value of the threshold of the limit input power of the second safety circuit 150 decreases as the driving frequency of the high-frequency inverter 191 decreases. For example, in the present embodiment, the threshold of the limit input power is set to 1100 W in a case where the driving frequency is 50.1 kHz to 65 kHz, and the threshold of the limit input power is set to 500 W in a case where the driving frequency is 50 kHz or less. However, in a case where the temperature difference between the central portion and the end portion of the fixing film 121 is less than 20° C., the threshold of the limit input power is set to be 1100 W even when the driving frequency is 50 kHz or less as in a case where the driving frequency is 50.1 kHz to 65 KHz.

Therefore, for example, in a case where the driving frequency reset in step S302 is 50 kHz or less, the CPU 140 resets the threshold of the limit input power of the second safety circuit 150 from 500 W to 1100 W in step S105.

By performing such control, even in a case where the electric resistance value R of the fixing film 121 in the circulating direction slightly varies due to a manufacturing variation, it is possible to implement a safety circuit configuration capable of absorbing the variation. On the other hand, in a case where the temperature difference is 20° C. or more, the processing proceeds to step S112 as before, and the CPU 140 only resets the driving frequency and the input power. At this time, the threshold of the limit input power of the second safety circuit 150 is not reset, and the current value is maintained.

As described above, in the present embodiment, the threshold of the limit input power can be changed for an appropriate driving frequency suitable for each fixing film 121 by also considering a result of detecting the temperature difference between the central portion and the end portion of the fixing film 121. As a result, even if there is a manufacturing variation of the fixing film 121, it is possible to prevent the temperature of the central portion of the film from locally rising to an abnormal temperature and damaging peripheral members of the film.

In the above-described embodiment, the table illustrated in FIG. 23A is used for resetting the threshold of the limit input power of the second safety circuit 150, and an example in which the threshold does not decrease even when the driving frequency is 50 kHz or less has been described. However, for example, the table illustrated in FIG. 23B may be used. That is, in a case where the driving frequency decreases, the threshold of the limit input power of the second safety circuit 150 also decreases as in a case where the temperature difference is 20° C. or more, but a range of decrease may be small. For example, in the example of FIG. 23B, in a case where the temperature difference is 20° C. or more, the threshold of the limit input power is set to 1100 W when the driving frequency is 50.1 kHz to 65 kHz, and the threshold is set to 500 W when the driving frequency is 50 kHz or less.

On the other hand, in a case where the temperature difference is less than 20° C., the threshold of the limit input power is set to 1100 W when the driving frequency is 50.1 kHz to 65 kHz, and the threshold is set to 900 W when the driving frequency is 50 kHz or less. As described above, in the table illustrated in FIG. 23B, when the temperature difference between the central portion and the end portion is less than 20° C., a reduction range of the limit input power of the second safety circuit 150 when the driving frequency is low is smaller than that when the temperature difference is 20° C. or more.

The second safety circuit 150 may be implemented using any electric circuit such as a CPU and an application specific integrated circuit (ASIC). In addition, for fail-safe purposes, the second safety circuit 150 is desirably configured as a separate component from the CPU 140 that controls the high-frequency inverter 191. However, the second safety circuit 150 and the CPU 140 may be implemented by the same control unit as functions of respective programs. Furthermore, the contents of the above-described embodiments may be combined in any way.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-155379, filed Sep. 9, 2024, hereby incorporated by reference herein in its entirety.

What is claimed is:

1. An image heating device configured to heat an image formed on a recording material, the image heating device comprising:
a tubular rotary member including a conductive layer;
a magnetic core material installed inside the rotary member and forming an open magnetic path in a longitudinal direction;
an excitation coil wound around the magnetic core material such that a spiral axis extends in the longitudinal direction of the magnetic core material;
an inverter configured to cause an alternating current to flow through the excitation coil;
a control unit configured to control the inverter to cause the alternating current to flow through the excitation coil and generate an alternating magnetic flux in the magnetic core material to perform electromagnetic induction heating of the rotary member; and
a power cutoff unit configured to cut off supply of power from the inverter to the excitation coil regardless of a control state of the inverter by the control unit in a case where the power input from the inverter to the excitation coil exceeds a threshold, wherein
the control unit is configured to change a driving frequency of the inverter, and
the power cutoff unit is configured to change a value of the threshold based on a value of the driving frequency of the inverter.

2. The image heating device according to claim 1, wherein the power cutoff unit is configured to set the threshold to a first value in a case where the driving frequency of the inverter is a first driving frequency, and set the threshold to a second value smaller than the first value in a case where the driving frequency of the inverter is a second driving frequency lower than the first driving frequency.

3. The image heating device according to claim 1, wherein the power cutoff unit is configured to set the threshold to a first value in a case where the driving frequency of the inverter is a first driving frequency, and set the threshold to a third value smaller than the first value in a case where the driving frequency of the inverter is a third driving frequency higher than the first driving frequency.

4. The image heating device according to claim 1, wherein the power cutoff unit includes a frequency detection unit configured to detect the driving frequency of the inverter.

5. The image heating device according to claim 1, further comprising a power detection unit configured to detect the power supplied from the inverter to the excitation coil based on the current flowing through the excitation coil.

6. The image heating device according to claim 5, wherein the power detection unit is configured to detect the power supplied from the inverter to the excitation coil based on the current flowing through the excitation coil and an alternating current voltage supplied to the inverter.

7. The image heating device according to claim 1, further comprising
a rotation detection unit configured to detect a rotation state of the rotary member,
wherein the power cutoff unit is configured to change the value of the threshold based on the value of the driving frequency of the inverter and the rotation state of the rotary member.

8. The image heating device according to claim 1, further comprising:
a first temperature detection element configured to detect a temperature of a central portion of the rotary member in an axial direction; and
a second temperature detection element configured to detect a temperature of an end portion of the rotary member in the axial direction,
wherein the power cutoff unit is configured to change the value of the threshold based on the value of the driving frequency of the inverter and a temperature difference between temperatures detected by the first and second temperature detection elements.

9. An image forming apparatus comprising:
an image forming unit configured to form a toner image on a recording material; and
the image heating device according to claim 1,
wherein the image heating device is a fixing device configured to heat the recording material on which the toner image is formed by the image forming unit to fix the toner image to the recording material.
